(19) United States
(12) Patent Application Publication
(10) Pub. No.: US 2023/0150821 A1
(43) Pub. Date: May 18, 2023

(54) CNT Filament Formation By Buoyancy Induced Extensional Flow

(71) Applicant: Nanocomp Technologies Inc., The Woodlands, TX (US)

(72) Inventor: David Gailus, Merrick, NH (US)

(21) Appl. No.: 17/916,860

(22) PCT Filed: Apr. 6, 2021
(86) PCT No.: PCT/US21/25931

§ 371 Date: Oct. 4, 2022

Related U.S. Application Data
(60) Provisional application No. 63/006,602, filed on Apr. 7, 2020.

(51) Int. Cl. C01B 32/162

(52) U.S. Cl. CPC C01B 32/162

(57) ABSTRACT

The present disclosure provides a method for producing elongated non-entangled nanotube filaments using a vertical upward flow floating catalyst chemical vapor deposition system.

### CROSS-REFERENCE TO RELATED APPLICATIONS

This application claims the benefit of and priority to U.S. Provisional Application No. 63/006,602, filed Apr. 7, 2020, which is hereby incorporated herein by reference in its entirety.

### STATEMENT REGARDING FEDERALLY SPONSORED RESEARCH OR DEVELOPMENT

This invention was made with Government support under DE-AR0001017 awarded by DOE, Office of ARPA-E. The Government has certain rights in this invention.

### FIELD

The present disclosure relates to carbon nanotube filaments in general and more particularly to a process for producing elongated non-entangled carbon nanotube filaments in an upward flow floating chemical vapor deposition system.

### BACKGROUND

Individual carbon nanotubes (CNTs) have extraordinary properties, but it is difficult to develop the long-range order of CNTs that is needed in large scale applications. Elongated CNTs tend to agglomerate and entangle as soon as they are produced, which is especially a problem for CNTs produced by floating catalyst chemical vapor deposition (FCCVD). Much work has been spent developing secondary operations that can de-agglomerate and reorganize the CNTs that are produced in a FCCVD process. Examples of this work include chemical or electrochemically assisted stretching or dissolution to form liquid crystal dopes followed by fiber spinning using superacids. Aligning the CNTs during their synthesis prior to agglomeration would be ideal, but it has been found to be difficult in practice. During the initial phase of the FCCVD process, CNTs form and grow in a carrier gas and behave essentially as a fluid. As the CNTs grow and their concentration increases, they can start to network, where the mechanical percolation starts to change the behavior from a fluid to a compressible, low density solid. This is analogous to gel point where elastic properties start to overwhelm the viscous properties of a material. Once this gelation occurs, it locks in disorder, and since it is very difficult to reorganize these CNTs at the nanoscale, this random entanglement ultimately limits the properties of the final CNT product.

Some alignment of the CNTs can be obtained by stretching the loosely entangled network, using the CNT-to-CNT interaction or the entrained associated gas to reorient the CNTs in the flow direction. However, it would be ideal if one could obtain some degree of alignment prior to the gelation. This could be possibly achieved by shear or extensional flow in the carrier gas, but there are practical obstacles to this approach. Work to create extensional flow includes acceleration by thermal expansion or creation of moles of gas phase material during the growth process in a fixed geometry reactor. Another approach is to introduce additional gases to accelerate the flow during the CNT formation step. A further approach is to design the reactor vessel itself, such as by tapering for instance, where the gas flow is accelerated prior to and during the gelation process. This last approach would be simple if the CNTs did not tend to stick to reactor surfaces. Tapered reactors or placement of aerodynamic lens are also possible, but they can increase the chance of fouling and the generation of CNT product defects. The present disclosure provides a non-contact method to generate the desired elongational flows thereby eliminating or reducing the fouling problem to produce elongated non-entangled CNTs.

### SUMMARY

The present disclosure relates to methods for producing elongated non-entangled nanotube filaments in an upward flow FCCVD system. The method generally includes (i) introducing a fluid mixture comprising (a) a metal catalyst precursor from which a metal catalyst particle can be generated for subsequent growth of the nanotube filaments thereon, (b) a conditioner compound for controlling size distribution of metal catalyst particles generated from the metal catalyst precursor, and (c) a carbon source for depositing carbon atoms onto the metal catalyst particle in order to grow elongated non-entangled nanotube filaments into a lower portion of a vertically orientated reactor filled with a pre-heated dense gas; (ii) propelling the fluid mixture upwardly through the reactor; (iii) initiating decomposition of the metal catalyst precursor into the metal catalyst particle and carbon source into carbon atoms causing the carbon atoms to be deposited onto the metal catalyst particle to form the elongated non-entangled nanotube filaments; and (iv) discharging the elongated non-entangled nanotube filaments from an upper portion of the vertically orientated reactor.

### BRIEF DESCRIPTION OF THE DRAWINGS

FIG. 1 illustrates a schematic diagram of a horizontal floating catalyst chemical vapor deposition system for production of nanostructures;

FIG. 2 is a schematic diagram of an upward flow vertical floating catalyst chemical vapor deposition system for production of nanostructures according to an embodiment of the present disclosure;

FIG. 2A is schematic illustration of an injector apparatus for use in connection with the system shown in FIG. 2;

FIG. 2B illustrates a schematic diagram of an upward flow vertical floating catalyst chemical vapor deposition system utilizing a plasma generator for production of nanostructures in connection with an embodiment of the present disclosure;

FIG. 2C illustrates a schematic diagram of a plasma generator suitable for use in connection with the system of FIG. 2B; and

FIG. 3 schematically depicts stream function contours for the upward flow vertical floating catalyst chemical vapor deposition system of the present disclosure.

### DETAILED DESCRIPTION

The present disclosure provides a method for producing elongated non-entangled nanotube filaments in an upward flow floating catalyst chemical vapor deposition system having a vertically oriented reactor. The method generally includes (i) introducing a fluid mixture into a lower portion of the vertically oriented reactor (such as at the bottom end or anywhere along a length of the vertically oriented reactor that is below the middle portion), wherein the lower portion of the vertically oriented reactor is filled with a pre-heated dense gas and wherein the fluid mixture comprises (a) a metal catalyst precursor from which a metal catalyst particle can be generated for subsequent growth of the nanotube filaments thereon, (b) a conditioner compound for controlling size distribution of metal catalyst particles generated from the metal catalyst precursor, and (c) a carbon source for depositing carbon atoms onto the metal catalyst particle in order to grow elongated non-entangled nanotube filaments; (ii) propelling the fluid mixture upwardly through the reactor; (iii) initiating decomposition of the metal catalyst precursor into the metal catalyst particle and carbon source into carbon atoms causing the carbon atoms to be deposited onto the metal catalyst particle to form the elongated non-entangled nanotube filaments; and (iv) discharging the elongated non-entangled nanotube filaments from an upper portion of the vertically orientated reactor (such as at the top end of the reactor).

The following terms shall have the following meanings:

The term “comprising” and derivatives thereof are not intended to exclude the presence of any additional component, step or procedure, whether or not the same is disclosed herein. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article.

The phrases “in one embodiment”, “according to one embodiment” and the like generally mean the particular feature, structure, or characteristic following the phrase is included in at least one aspect of the present disclosure, and may be included in more than one aspect of the present disclosure. Importantly, such phases do not necessarily refer to the same aspect.

If the specification states a component or feature “may”, “can”, “could”, or “might” be included or have a characteristic, that particular component or feature is not required to be included or have the characteristic.

“Carbon nanotubes”, as used herein, are used to refer to single, double, and/or multiwall carbon nanotubes having a diameter of less than about 1 nm to about 20 nm and a length of 1 mm to 5 mm.

“Carbon nanotube filament”, as used herein, refers to a staple fiber comprising a number of carbon nanotubes that are interconnected in substantially the same direction such as to form a fiber structure having a diameter in a range of from 0.1 to 10 microns and a length of about 150 mm to about 500 mm.

It should be noted that although reference is made herein to elongated non-entangled nanotube filaments synthesized from carbon, other compound(s) may be used in connection with the synthesis of nanotube filaments for use with the method of the present disclosure. For example, it is understood that elongated non-entangled nanotube filaments may be synthesized from, for example, boron, in a similar system but with different chemical precursors.

Furthermore, the present disclosure employs a floating catalyst chemical vapor deposition (“FCCVD”) process to generate the elongated non-entangled nanotube filaments. Since growth temperatures for the FCCVD process can be comparatively low ranging, for instance, from about 400° C. to about 1400° C., carbon nanotubes, single wall carbon nanotubes (SWNT), multiwall carbon nanotubes (MWNT) or both, may be grown. Although both SWNT and MWNT may be grown, in certain instances, it may be preferred to selectively grow SWNT because of their higher growth rate and tendency to form ropes which may offer handling, safety and strength advantages.

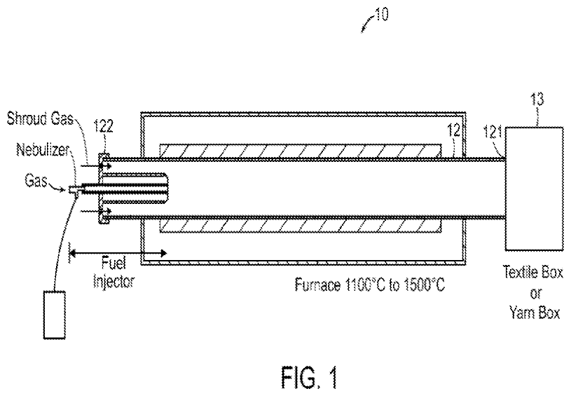

Referring now to FIG. 1, a state-of-the-art current practice of employing an essentially horizontal FCCVD system 10 is depicted having a horizontal axis of symmetry a. Initial FCCVD gases are horizontally introduced to an inlet situated at end 122 of reactor tube 12. The reactor tube 12 is heated within housing 11 and the resultant carbon nanotube material, typically entangled, exits from an outlet located at end 121 and collected in collection unit 13. Typical controls, safety devices, instrumentation, ports, etc. are not shown or described for simplicity.

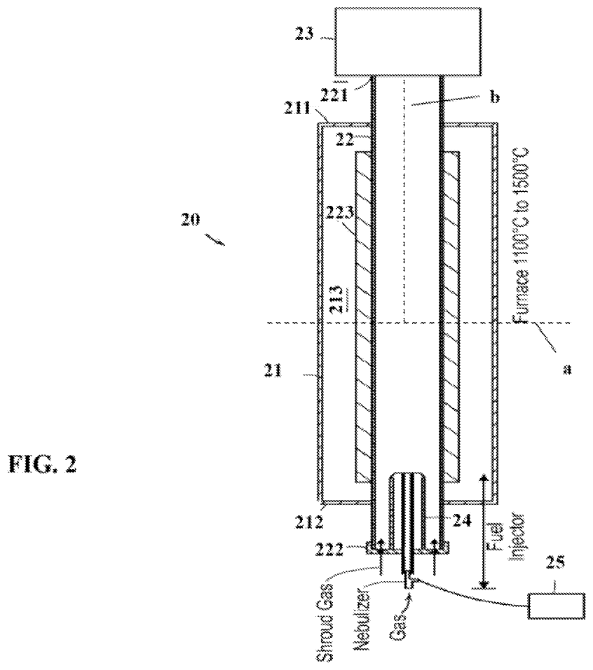

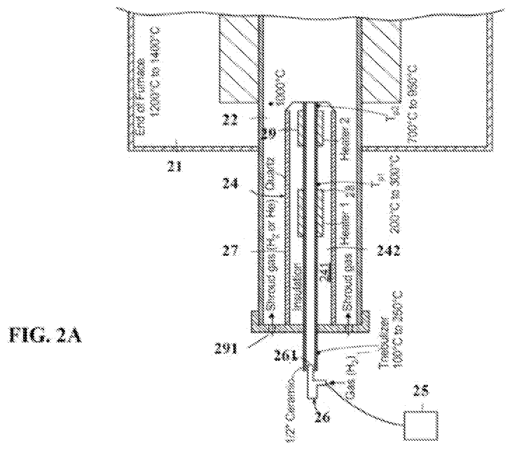

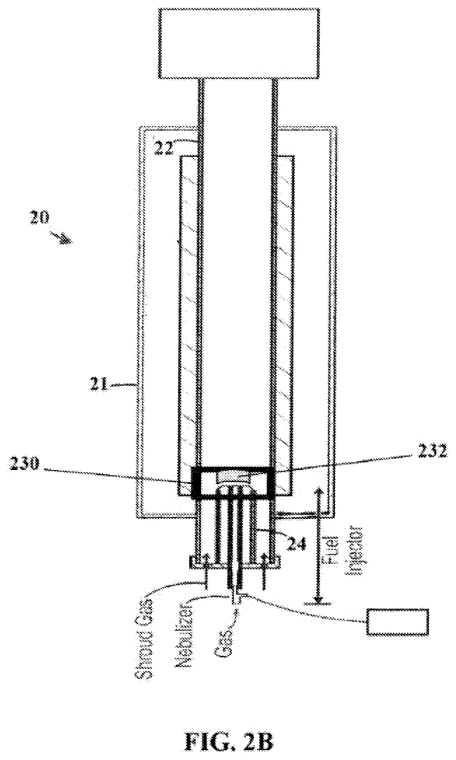

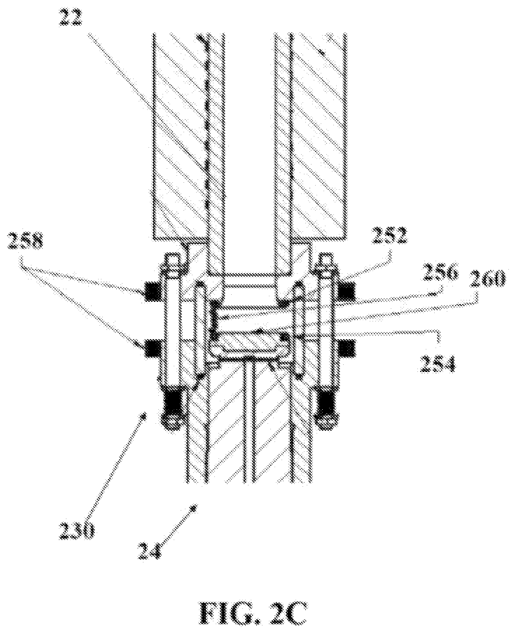

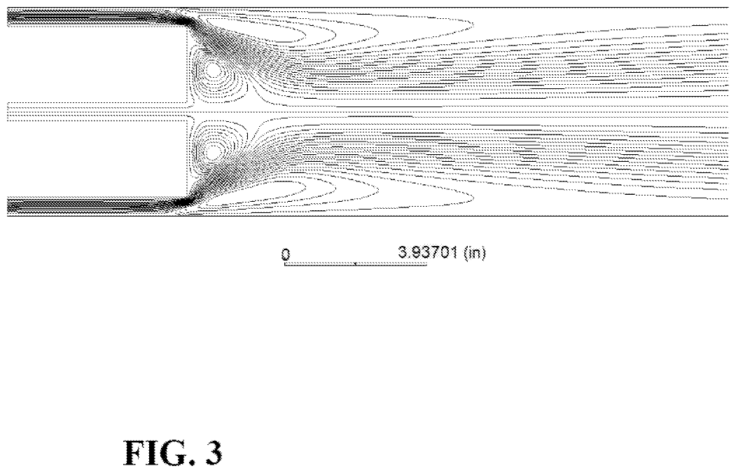

FIG. 2 represents an embodiment of the present disclosure in which a conventional horizontal system is rotated to provide an upward flow chemical vapor deposition system 20 having a vertical axis of symmetry b at least substantially perpendicular to horizontal axis of symmetry a, in which the elongated non-entangled carbon nanotube filaments may be obtained. System 20 includes housing 21 (i.e., furnace) having opposite ends 211 and 212, and a passageway 213 extending between ends 211 and 212. A tube 22 (i.e., vertically oriented reactor) having an upper portion and a lower portion within which the elongated non-entangled carbon nanotube filaments may be generated may be situated within the passageway 213 of housing 21. Tube 22 is at least partially filled with a pre-heated dense gas, such as, but not limited to, argon, sulfur hexafluoride (SF₆), carbon monoxide or mixtures thereof. These dense gases have been pre-heated to a temperature of at least about 100° C., or at least about 200° C., or at least about 300° C. or at least about 400° C., or at least about 500° C., or at least about 600° C. or at least about 700° C., or at least about 800° C., or at least about 900° C. or at least about 1000° C., or a temperature in a range of from 100 to 1000° C., or from 200 to 1000° C., or from 300 to 1000° C., or from 400 to 900 ° C., or from 500 to 800° C., or from 600 to 800 ° C., so that they are denser than the incoming injected CVD gases (i.e. fluid mixture) which enter at end 222 (or lower end of tube 22). The concentration of the dense gases within tube 22 may be at least about 10 mole % or at least about 20 mole % or at least about 30 mole % or at least about 40 mole % or at least about 50 mole % or at least about 60 mole % or at least about 70 mole % or at least about 80 mole % or at least about 90 mole % or at least about 99.9 mole %. In one embodiment, only the bottom half of the tube 22 is filled with the pre-heated dense gas. In another embodiment, less than half of the tube 22 is filled with the pre-heated dense gas, wherein the pre-heated dense gas is localized in the bottom half of the tube 22. On injection of the incoming fluid mixture, heat is transferred from the pre-heated dense gas within tube 22 to the light incoming fluid mixture feedstock by conduction/convection and from the walls of tube 22 by radiation. Concurrently, the buoyancy starts to stretch the flow of the fluid mixture as shown in FIG. 3 such that the fluid mixture is propelled upward, and elongated nanotube filaments are produced. FIG. 3 shows stream function contours of the vertical up-flow of the fluid mixture. In this case, low injection flow rates establish annular vortex which can potentially promote mixing and heat transfer. Although centralized flow may be unstable, if this is so, such flow may be stabilized by inducing rotation of tube 22.

Referring again to FIG. 2, ends 221 and 222 of tube 22 may be positioned so that they extend from ends 211 and 212 respectively of housing 21. Housing 21 may include heating elements or other mechanisms (such as a slot furnace) to generate temperatures ranging between about 1000° C. to about 1500° C., which are necessary for the growth of carbon nanotubes within tube 22. As the heating elements or other mechanisms must maintain the temperature environment within tube 22 to within a specified range during the synthesis of the elongated non-entangled carbon nanotube filaments, although not illustrated, the system 20 may include a thermocouple on the exterior of tube 22 to monitor the temperature environment within tube 22. The maintenance of the temperature range within tube 22 at, for example, from about 1100° C. to about 1400° C., may be optimized by the use of an insulating structure 223. Insulating structure 223 may be made from, for example, zirconia ceramic fibers (e.g., zirconia-stabilized boron nitride). Other insulating materials may also be used.

In one embodiment, the step of initiating decomposition of the carbon source into carbon atoms causing the carbon atoms to be deposited onto the metal catalyst particle to form the elongated non-entangled nanotube filaments comprises heating the carbon source to a temperature ranging from 1000° C. to 1500° C. or, more specifically, 1100° C. to 1400° C.

As the housing 21 and tube 22 must withstand variations in temperature and gas-reactive environments, housing 21 and tube 22 may be manufactured from a strong, substantially gas-impermeable material that is substantially resistant to corrosion. The housing 21 and tube 22 may be made from a quartz or ceramic material, such as, for example, Macor® machinable glass ceramic, to provide enhanced shock absorption. Of course, other materials may also be used, so long as the housing 21 and tube 22 can remain impermeable to gas and maintain their non-corrosive character. Also, although illustrated as being cylindrical in shape, housing 21 and tube 22 may be provided with any geometric cross-section.

System 20 may also include a collection unit 23 in fluid communication with end 221 of tube 22 for collecting the nanotube filaments generated within tube 22. At opposite end 222 of tube 22, system 20 may include an injector apparatus 24 (i.e., nebulizer) in fluid communication with tube 22. Injector 24 may be designed to receive from a reservoir 25 a fluid mixture of components necessary for the growth of nanotube filaments within tube 22. Injector 24 may also be designed to vaporize or fluidize the mixture (i.e., generating small droplets) before directing the mixture into tube 22 for the generation and growth of the nanostructured material. In some embodiments, mmultiple filaments could be produced from an injector array (not shown), such as a device similar to a spinneret commonly used in gel spinning.

The fluid mixture entering at end 222, in one embodiment, can include, among other things, (a) a metal catalyst precursor from which a metal catalyst particle can be generated for subsequent growth of the nanotube filaments thereon, (b) a conditioner compound for controlling size distribution of metal catalyst particles generated from the metal catalyst precursor, and thus the diameter of the nanotube filaments, and (c) a carbon source for depositing carbon atoms onto the metal catalyst particle in order to grow the elongated non-entangled nanotube filaments.

Examples of the metal catalyst precursor from which metal catalyst particles may be generated include Ferrocene, iron or iron alloy, nickel, cobalt, their oxides, or their alloys (or compounds with other metals or ceramics). Alternatively, the metal catalyst particles may be made from metal oxides, such as Fe₃O₄, Fe₂O₄, or FeO, similar oxides of cobalt or nickel, or a combination thereof.

Examples of the conditioner compound for use in connection with the fluid mixture of the present disclosure include thiophene, H₂S, other sulfur containing compounds, or a combination thereof.

The carbonaceous gas may comprise at least one of (i) a treated or untreated flare gas, (ii) hydrocarbons such as methane, ethane, butane, and/or propane, (iii) natural gas, and/or (iv) other hydrocarbons like xylene, toluene, and benzene. Commercial grade natural gas primarily comprises methane and some ethane, propane, and butane. The amount of methane in commercial grade natural gas can range from 70 wt % to greater than 90 wt % of the natural gas.

Examples of the carbon source for use in connection with the fluid mixture of the present disclosure include, but are not limited to, treated or untreated flare gas, ethanol, methyl formate, propanol, acetic acid, hexane, methanol, or blends of methanol with ethanol. Other liquid carbon source may also be used, including C₂H₂, CH₃, and CH₄.

The flare gas may be obtained from an oil or gas production site, a refinery, a chemical plant, a coal plant, or landfill. In one embodiment, the system used to produce the carbon nanotubes is onsite at the oil or gas production site, refinery, chemical plant, coal plant, or landfill so that the flare gas can be obtained directly from the source and treated before being introduced into the reactor.

The step of treating the flare gas comprises subjecting the flare gas to one or more processes to remove excess hydrogen sulfide, hydrogen disulfide, carbon dioxide, and/or carbon monoxide therefrom. As used herein, “excess” is meant an amount sufficient to cause the flare gas to be considered sour gas and have detrimental impact on the ability to produce carbon nanotubes.

In one embodiment, the fluid mixture is propelled upwardly through the vertically oriented reactor 22 by the use of a fan or a sufficient flow of the fluid mixture or another inert gas (e.g., hydrogen, helium, nitrogen, or any other inert gas) into the base of the system 20 and through the vertically oriented reactor 22. In one particular embodiment, the fluid mixture is introduced into the vertically oriented reactor 22 at a rate of 1 to 5 standard liters per minute (SLPM), which is sufficient to propel the fluid mixture upwards through the vertically oriented reactor 22.

In one embodiment, the step of initiating decomposition of the metal catalyst precursor into the metal catalyst particles comprises heating the metal catalyst precursor to a temperature greater than 200° C., or greater than 300° C., or greater than 400° C., or greater than 500° C. In one particular embodiment, the step of initiating decomposition of the metal catalyst precursor into the metal catalyst particles comprises heating the metal catalyst precursor to a temperature in a range of from 200° C. to about 300° C.

In some embodiments, the carbon nanotube filaments can have an aspect ratio in a range of from about 25:1 to 5000:1, or 25:1 to 4000:1, or 25:1 to 3000:1, or 25:1 to 2000:1, or 25:1 to 1000:1, or 25:1 to 500:1, or 30:1 to 500:1, or 50:1 to 250:1. In another embodiment, the carbon nanotube filaments can be arranged in a parallel relationship without requiring significant post-processing steps such as chemical (e.g., acid treatment) and/or stretching.

With reference now to FIG. 2A, there is shown a detailed illustration of injector 24. Injector 24 includes a substantially tubular chamber 241 defining a pathway 242 along which the vaporized fluid mixture may be generated and directed into reactor tube 22. To vaporize or fluidize the mixture, injector 24 may include a nebulizing tube 26 designed to impart a venturi effect in order to generate small droplets from the fluid mixture being introduced from reservoir 25. It should be appreciated that the vaporizing or fluidizing of the fluid mixture may occur substantially as the fluid exits through distal end 261 of nebulizing tube 26. The droplets being generated may range from nanoscale in size to microscale in size. To direct the vaporized fluid mixture along the nebulizing tube 26 into the reactor tube 22, a volume of gas, such as H₂, He or any other inert gas(es), may be used to push or propel the vaporized fluid toward the reactor tube 22.

Although illustrated as substantially tubular, it should be appreciated that injector 24 may be provided with any geometric designs, so long as the injector can accommodate the nebulizing tube 26, and provide a pathway along which the vaporized fluid mixture can be directed into reactor tube 22.

In addition, it should be noted that the injector 24 may be designed to permit introduction of individual components of the fluid mixture into the injector 24 rather than providing them as part of the fluid mixture. In such an embodiment, each component may be individually vaporized, through a nebulizing tube similar to tube 26, and introduced into the injector 24, where they may be allowed to mix and subsequently be directed along the injector 24 in a similar manner to that described above.

As injector 24 is situated within a portion of reactor tube 22 and furnace 21, the heat being generated within tube 22 and furnace 21 may have a negative effect on the temperature environment within injector 24. In order to shield injector 24 from the heat in reactor tube 22 and furnace 21, an insulation package 27 may be provided about injector 24. In particular, insulation package 27 may act to preserve the temperature environment along the length of injector 24.

With the presence of insulation package 27, the temperature environment within injector 24 may be lowered to a range which can affect the various reactions necessary for growing the carbon nanostructured material. To that end, injector 24 may also include a heating zone A situated downstream from the nebulizing tube 26 to provide a temperature range sufficient to permit the formation of metal catalyst particles from the metal catalyst precursors. The heating zone A may include a first heater 28 situated downstream of the distal end 261 of nebulizing tube 26. Heater 28 may be provided to maintain a temperature range at, for instance, Tₚ₁ necessary to decompose the metal catalyst precursor into its constituent atoms, and which atoms may thereafter cluster into metal catalyst particles on which nanostructures may subsequently be grown. In order to maintain the temperature range at Tₚ₁ at a level necessary to decompose the metal catalyst precursor, heater 28, in one embodiment, may be situated slightly downstream of Tₚ₁. In an embodiment where ferrocene is used as a precursor, its constituent atoms (i.e., iron particles), substantially nanoscaled in size, may be generated when the temperature at Tₚ₁ can be maintained in a range of from about 200° C. to about 300° C.

Heating zone A may further include a second heater 29 positioned downstream of first heater 28, and within furnace 21. Heater 29 may be provided to maintain a temperature range at, for example, Tₚ₂ necessary to decompose the conditioner compound into its constituent atoms. These atoms, in the presence of the clusters of metal catalyst particles, can interact with the clusters to control the size distribution of the metal catalyst particles, and hence the diameter of the nanostructures being generated. In an embodiment where thiophene is used as a conditioning compound, sulfur may be released upon decomposition of the thiophene to interact with the clusters of metal catalyst particles. Heater 29, in an embodiment, may be designed to maintain a temperature range at Tₚ₂ from about 700° C. to about 950° C. and to maintain such a range at a location slightly downstream of the heater 29.

In accordance with one embodiment, Tₚ₂ may be located at a desired distance from Tₚ₁. As various parameters can be come into play, the distance from Tₚ₁ to Tₚ₂ should be such that the flow of fluid mixture from Tₚ₁, where decomposition of the metal catalyst precursor occurs, to Tₚ₂ can optimize the amount of decomposition of the conditioning compound, in order to optimize the size distribution of the metal catalyst particles.

It should be appreciated that in addition to the particular temperature zones generated by first heater 28 and second heater 29 within injector 24, the temperature at the distal end 261 of nebulizing tube 26 may also need to be maintained within a particular range in the injector 24 in order to avoid either condensation of the vaporized fluid mixture or uneven flow of the fluid mixture as it exits through distal end 261 of nebulizing tube 26. In an embodiment, the temperature at the distal end 261 may need to be maintained between about 100° C. and about 250° C. If, for example, the temperature is below the indicated range, condensation of the fluid mixture may occur along a wall surface of the injector 26. Consequently, the fluid mixture that is directed from the injector 26 into the reactor tube 22 may be substantially different from that of the mixture introduced from reservoir 25. If, for example, the temperature is above the indicated range, boiling of the fluid mixture may occur at the distal end 261, resulting in sputtering and uneven flow of the fluid into the injector 24.

As injector 24 may need to maintain a temperature gradient along its length, whether to minimize condensation of the distal end 261 of the nebulizing tube 26, to maintain the necessary temperature at Tₚ₁ to permit decomposition of the metal catalyst precursor, or at Tₚ₂ to permit decomposition of the conditioning compound, insulation package 27, in addition to shielding heat from the reactor tube 22 and furnace 21, can act to maintain the desired temperature gradient along injector 24 at each critical location.

In one embodiment, the insulation package 27 may be made from quartz or similar materials, or from a porous ceramic material, such as zirconia ceramic fibers (for e.g., zirconia-stabilized boron nitride). Other insulating materials may also, of course, be used.

With continued reference to FIG. 2A, system 20 may include at least one inlet 291 through which a carrier gas may be introduced into reactor tube 22. The introduction of a carrier gas into tube 22 may assist in moving the fluid mixture along tube 22 subsequent to its exit from injector 24. In addition, as it may be desirable to minimize turbulent flow or vortex flow associated with the fluid mixture as it exits injector 24, the carrier gas may be permitted to flow along the reactor tube 22 and along an exterior surface of injector 24. In an embodiment the carrier gas may be permitted to flow at a speed substantially similar to that of the fluid mixture, as the mixture exits the injector 24, to permit the fluid mixture to maintain a substantially laminar flow. By maintaining a substantially laminar flow, growth and strength of the nanotube filaments being produced may be optimized. In an embodiment, the carrier gas may be H₂, He or any other inert gas.

To further minimize turbulent flow or vortex flow as the fluid mixture exits the injector 24, insulation package 27 may be provided with a substantially tapered design about distal end of injector 24. Alternatively, or in addition, an extension (not shown) may be situated about distal end of injector 24 to expand the flow of the fluid mixture substantially radially away from the center of the injector 24 as the fluid mixture exits the distal end of the injector. The presence of such an extension can slow down flow velocity of the fluid mixture and allow the flow pattern to remain substantially laminar.

It should be appreciated that the injector 24 may be designed to decompose the metal catalyst precursor at Tₚ₁ and the conditioning compound at Tₚ₂ as the fluid mixture moves along injector 24. However, the carbon source necessary for nanostructured growth does not get decomposed and may remain substantially chemically unchanged as the fluid mixture moves along injector 24.

However, since the distal end of injector 24 protrudes into furnace 21, as seen in FIGS. 2-2A, its proximity to a substantially higher temperature range within the furnace 21, and thus reactor tube 22, can expose the carbon source immediately to a temperature range necessary to decompose the carbon source, upon its exiting through the distal end of the injector 24, for subsequent nanotube filament growth. In an embodiment, the temperature range at interface 242 between distal end of the injector and furnace 21 may be from about 1000° C. to about 1250° C.

With reference to FIG. 2B and FIG. 2C, a plasma generator 230 may be disposed about the distal end of the injector 24. In this manner, the fluid mixture may be passed through a plasma flame 232 of the plasma generator 230 before entering the reactor tube 22. In an embodiment, there may be provided hermetic seals or fluid tight seals around the junctions between the plasma generator 230 and the injector 24, as well as between the plasma generator 230 and the reactor tube 22 to prevent gases and particles in the fluid mixture from escaping from the system 20. In one embodiment, the plasma generator 230 may be in an axial or linear alignment with the injector 24 to provide an efficient flow path for the fluid mixture from the injector 24 and through the plasma generator 230. In an embodiment, the alignment of the plasma generator 230 with the injector 24 is such that the fluid mixture is allowed to pass substantially through the middle of the plasma generator 230. In some embodiments, this may lead to the fluid mixture passing through the middle region of the plasma flame 232, which may have a more uniform temperature profile than the outer regions of the plasma flame 230. The plasma generator 230 may also be in an axial or linear alignment with the reactor tube 22.

In an embodiment, the plasma generator 230 may provide concentrated energy, in the form of the plasma flame 232, to increase the temperature of the fluid mixture to a temperature higher than the temperature range in the injector 24. In an embodiment, the plasma generator 230 can increase the temperature of the fluid mixture to a level sufficient to decompose the carbon source into its constituent atoms for activation of nanostructure growth. In an embodiment, the plasma generator 230 may operate between about 1200° C. and about 1700° C. Because the temperature of the plasma flame 232 is substantially higher than the temperature in the injector 24, the heat generated by the plasma flame 232 may have a negative effect on the temperature environment within the injector 24. To that end, the plasma generator may be provided with a heat shield 260 situated between the region of the plasma generator 230 where the plasma flame 232 is generated and the injector 24 to preserve the temperature environment along the length of injector 24. In one embodiment, the heat shield 260 may be made from a porous ceramic material, such as zirconia ceramic fibers (e.g., zirconia-stabilized boron nitride). Other insulating materials may, of course, also be used.

Because the plasma generator 230 may provide concentrated energy to the fluid mixture thereby initiating quicker decomposition of the carbon source, in one embodiment, a shorter reactor tube 22, the furnace 21, or both may be used and still generate nanotubes of sufficient length. Of course to the extent desired, reactor tube 22, the furnace 21, or both may be provided with similar or longer lengths than in systems without a plasma generator. In an embodiment, utilizing the plasma generator 230 in the process may enable production of longer carbon nanotubes.

It should also be noted that in some embodiments, the injector 24 and plasma generator 230 may be utilized with minimal heat or without additional heat in the reaction tube 22. It should also be noted that multiple plasma generators may be utilized in the system 20 to provide a desired temperature gradient over a travel distance of the fluid mixture.

FIG. 2C illustrates one embodiment of the plasma generator 230. In an embodiment, the plasma generator 230 may be a direct current (DC) power generator. The plasma generator 230 may include an anode 252 and a cathode 254, which can be cooled by water or another cooling fluid or another material that may act as a heat sink to transfer the heat away from the electrodes 252, 254. In an embodiment, the electrodes 252, 254 may be high diffusivity-metal electrodes, such as typically made of copper or silver. Plasma gas may flow around the anode 252 and cathode 254 and may be ionized by an electric arc 256 initiated between the anode 252 and cathode 254 to create plasma flame. Suitable plasma gasses may be either reactive or non-reactive and may include, but are not limited, argon oxygen, nitrogen, helium, hydrogen or another gas. In an embodiment, the plasma generator 230 may include one or more Helmholtz coils 258 or another device for producing magnetic field for rotating the arc 256. In such an embodiment, the anode 252 and cathode 254 may be provided with an annular shape to facilitate rotation of the arc 256. While FIG. 2C illustrates one suitable embodiment of a plasma generator, other designs and types of plasma generators (i.e. radio frequency, alternating current and other discharges plasma generators) may be implemented.

In an embodiment, the Helmholtz coils 258 can be used to generate an electromagnetic or electrostatic field for in situ alignment of the nanotubes downstream of the plasma generator 230 in the reactor tube. Additionally or alternatively, the electromagnetic field created by the plasma generator 230 can act to deflect the carbon nanotubes towards the axis of the reaction tube 22 by generating a torque on the carbon nanotubes, packing the carbon nanotubes towards such axis. In an embodiment the plasma generator 230 can also be designed to push or focus the cloud of carbon nanotubes into a smaller radial volume as the cloud of carbon nanotubes proceeds through the reaction tube 22. In an embodiment, particles from which carbon nanotubes grow can be charged by a particle charger so that the particles can respond to electrostatic forces.

To the extent more than one plasma generator 230 is used, the plasma generators' field strength and position can be optimized to align the carbon nanotubes. Additionally or alternatively, the power generators may be in linear alignment with one another, and each successive downstream plasma generator may be configured to generate a stronger electrostatic field, so as to force or condense the flowing cloud of carbon nanotubes toward a smaller radial volume, while moving the carbon nanotubes in a substantial axial alignment with the reaction tube 22. In some embodiments, the successive plasma generators can also be used to control the flow acceleration or deceleration, allowing the nanotubes to radially condense toward a filament like shape. Such an approach toward condensing the flow of carbon nanotubes can force the carbon nanotubes to be in closer proximity to enhance contact between adjacent nanotubes. Contacts between adjacent carbon nanotubes can be further enhanced via non-covalent interactions between the carbon nanotubes, such as London dispersion forces or van der Waals forces.

Turing back to FIG. 2A, in operation, a number of processes may be occurring in a region between the nebulizing tube 26 and the main furnace 21 of system 20. For instance, initially, the fluid mixture of metal catalyst precursor, conditioning compound and carbon source may be introduced from reservoir 25 into injector 24 by way of nebulizing tube 26. To assist in directing the fluid mixture along the nebulizing tube 26, an inert gas, such as H₂ or He may be used. As the fluid mixture moves along the nebulizing tube 26 and exits therefrom, tube 26 can impart a venturi effect to vaporize the fluid mixture (i.e., generate droplets from the fluid mixture). To minimize any occurrences of condensation or boiling as the fluid mixture exits the nebulizing tube 26, such an area within the injector 24 may be maintained at a temperature level ranging from about 100° C. to about 250° C.

In an embodiment, an additive for the carbon source may be included in the fluid mixture to optimize growth conditions, as well as enhancing the strength of carbon nanotube material made from the carbon nanotubes being produced. Examples of additives include, but are not limited to, C₆₀, C₇₀, C₇₂, C₈₄, and C₁₀₀.

The vaporized fluid mixture may then proceed along the injector 24 toward the first heater 28 where the temperature may be maintained at Tₚ₁ at levels ranging from about 200° C. to about 300° C., the metal catalyst precursor within the fluid mixture may be decomposed, releasing its constituent atoms. The decomposition temperature of the metal catalyst precursor, in an embodiment, can be dependent on the carrier gas (for e.g., H₂ or He), and may depend on the presence of other species. The constituent atoms may subsequently cluster into metal catalyst particles of a characteristic size distribution. This size distribution of the metal catalyst particles can, in general, evolve during migration through the injector 24 and into the furnace 21.

Next, the fluid mixture may proceed further downstream along the injector 24 toward the second heater 29. The second heater 29, in an embodiment, may maintain the temperature at Tₚ₂ at a level ranging from about 700° C. to about 950° C. where the conditioning compound may decompose into its constituent atoms. The constituent atoms of the conditioning compound may then react with the clusters of metal catalyst particles to effectuate the size distribution of the clusters of metal catalyst particles. In particular, the constituent atoms of the conditioning compound can act to stop the growth and/or inhibit evaporation of the metal catalyst particles. In an embodiment, the constituent atoms of the conditioning compounds along with H₂ in the injector 24 may interact with the clusters of metal catalyst particles to affect size distribution of the metal catalyst particles.

It should be appreciated that the carbon source within the fluid mixture may remain chemically unchanged or otherwise not decomposed within injector 24, as the fluid mixture travels along the entire length of the injector 24.

The conditioned metal catalyst particles once moved beyond the second heater 29 may thereafter move out of the injector 24 and into the furnace 21 to enter into the main portion of reactor tube 22 filled with the pre-heated dense gas. Upon exiting the injector 24, the conditioned metal catalyst particles, along with the carbon source, may maintain a substantially laminar flow in the presence of a carrier gas, such as H₂ or He. In the presence of the carrier gas, the conditioned metal catalyst particles may be diluted by the volume of carrier gas.

In addition, upon entry into the main portion of the reactor tube 22, where the temperature range within the reactor tube 22 may be maintained at a level sufficient to decompose the carbon source into its constituent carbon atoms, the presence of the carbon atoms can activate nanotube filament growth. In an embodiment, the temperature range may be from about 1000° C. to about 1250° C. In general, growth occurs when the carbon atoms attach themselves substantially sequentially upon the metal catalyst particles to form a nanotube filament, such as a carbon nanotube filament.

In an embodiment, the fluid mixture from the injector 24 may be passed through the plasma generator 230 before entering the reactor tube 22.

As described above, upon entering the main portion of the reactor tube 22, heat is transferred from the dense gas to the light fluid mixture by conduction/convection and from the walls of the reactor tube 22 by radiation. Concurrently, the buoyancy starts to stretch the flow of the fluid mixture such that elongated non-entangled nanotube filaments are produced. In addition, the flow of the fluid mixture within the main portion of the reactor tube 22 is such that minimal or substantially no nanotube filaments contact the walls of the reactor tube 22.

Growth of the nanotube filaments may end when the metal catalyst particles become inactive, the concentration of constituent carbon atoms near the metal catalyst particles is reduced to a relatively low value, or the temperature drops as the mixture moves beyond an area within the reactor tube 22 where the temperature range is maintained at a sufficient level for growth.

According to another embodiment, there is provided a vertically orientated upward flow FCCVD system for producing elongated nanotube filaments comprising (i) a reactor having a lower end, an upper end and an inner cavity configured for holding a dense gas; (ii) an injector positioned at the lower end of the reactor configured for propelling a fluid mixture into the reactor, the fluid mixture comprising a) a metal catalyst precursor from which a metal catalyst particle can be generated for subsequent growth of the nanotube filaments thereon, (b) a conditioner compound for controlling size distribution of metal catalyst particles generated from the metal catalyst precursor, and (c) a carbon source for depositing carbon atoms onto the metal catalyst particle in order to grow the elongated non-entangled nanotube filaments, (iii) a furnace surrounding the reactor configured to heat the reactor to a temperature sufficient to generate metal catalyst particles from the metal catalyst precursor and carbon atoms from the carbon source, and (iv) a collection unit positioned at the upper end of the reactor configured to collect the elongated nanotube filaments produced within the reactor.

Although making and using various embodiments of the present invention have been described in detail above, it should be appreciated that the present invention provides many applicable inventive concepts that can be embodied in a wide variety of specific contexts. The specific embodiments discussed herein are merely illustrative of specific ways to make and use the invention, and do not delimit the scope of the invention.

What is claimed is:

1. A method for producing elongated non-entangled nanotube filaments comprising:
(i) introducing a fluid mixture into a lower portion of a vertically orientated reactor at least partially filled with a pre-heated dense gas, wherein the fluid mixture comprises (a) a metal catalyst precursor, (b) a conditioner compound, and (c) a carbon source;
(ii) propelling the fluid mixture upwardly through the vertically oriented reactor;
(iii) initiating decomposition of the metal catalyst precursor into metal catalyst particles and the carbon source into carbon atoms;
(iv) allowing the carbon atoms to be deposited onto the metal catalyst particles to form elongated non-entangled nanotube filaments; and
(v) discharging the elongated non-entangled nanotube filaments from an upper portion of the vertically orientated reactor.

2. The method of claim 1, wherein the dense gas comprises argon, sulfur hexafluoride (SF₆), carbon monoxide, or a combination thereof.

3. The method of claim 1, wherein the concentration of the dense gas in the vertically oriented reactor is at least 10 mole percent.

4. The method of claim 1, wherein the bottom half of the vertically oriented reactor is substantially filled with the dense gas.

5. The method of claim 1, wherein the metal catalyst precursor is ferrocene.

6. The method of claim 1, wherein the conditioner compound comprises thiophene, H₂S, other sulfur containing compounds, or a combination thereof

7. The method of claim 1, wherein the fluid mixture is introduced at volumetric flow rate of 1 to 5 standard liter per minute.

8. A vertically orientated upward flow floating catalyst chemical vapor deposition system for producing elongated nanotube filaments comprising (i) a vertically oriented reactor having a lower end, an upper end and an inner cavity containing a dense gas; (ii) an injector positioned at the lower end of the vertically oriented reactor configured for propelling a fluid mixture upwardly into the vertically oriented reactor, the fluid mixture comprising a) a metal catalyst precursor, (b) a conditioner compound, and (c) a carbon source, (iii) a furnace surrounding the vertically oriented reactor, and (iv) a collection unit positioned at the upper end of the vertically oriented reactor configured to collect the elongated nanotube filaments produced within the vertically oriented reactor.

9. The system of claim 8, wherein the dense gas comprises argon, sulfur hexafluoride (SF₆), carbon monoxide, or a combination thereof.

10. The system of claim 8, wherein the concentration of the dense gas in the vertically oriented reactor is at least 10 mole percent.

11. The system of claim 8, wherein the bottom half of the vertically oriented reactor is substantially filled with the dense gas.
